(19) United States
(12) Patent Application Publication
(10) Pub. No.: US 2002/0116951 A1
(43) Pub. Date: Aug. 29, 2002

(54) Conformally heated male mold

(76) Inventors: Thomas A. Dunifon, Whitehouse, OH (US); Jennifer R. Wolfe, Curtice, OH (US)

Correspondence Address: MARSHALL & MELHORN, FOUR SEAGATE, EIGHT FLOOR, TOLEDO, OH, 43604, US

(21) Appl. No.: 09/956,524

(22) Filed: Sep. 19, 2001

Related U.S. Application Data
(60) Provisional application No. 60/271,750, filed on Feb. 27, 2001.

(51) Int. Cl. C03B 23/03

(52) U.S. Cl. 65/106; 65/273; 264/225

(57) ABSTRACT

An improved male mold for press bending sheets of glass includes, as heating elements, heating wires which are disposed in the male mold in a manner which conforms to the outer surface of the male mold. These heating wires provide a more uniform temperature profile over the pressing surface of the male mold, thus more uniformly heating sheets of glass. Additionally, a method is provided of making a male mold for press bending sheets of glass with such conformal heating elements.

### CROSS REFERENCE TO RELATED APPLICATION

This application is related to the copending application entitled “HEATED CERAMIC FEMALE MOLD”, filed on the same date as the present application, and having the inventors Thomas A. Dunifon and Jennifer R. Wolfe. The above-identified application is hereby expressly incorporated by reference, as if set forth in its entirety herein.

### BACKGROUND OF THE INVENTION

1. Field of the Invention

The present invention relates generally to the production of curved glass sheets and, more particularly, to an improved apparatus for press bending relatively thin sheets of glass.

2. Description of the Prior Art

Curved sheets of glass are commonly used as glazing closures or windows of vehicles such as automobiles and the like. For such applications, it is imperative that the sheets be bent to precisely defined curvatures determined by the configurations and sizes of the window openings as well as the overall styling of the vehicle. Further, it is required that the bent sheets meet stringent optical requirements and that the viewing area of the closures or windows be free of surface defects and optical distortion that would tend to interfere with the clear viewing therethrough. Thus, it can be appreciated that not only is it required to have bending apparatus that will shape glass sheets to precise curvatures, but also that it will do so without causing serious optical defects to the surfaces thereof.

One commercial method of producing such curved sheets generally includes heating pretrimmed, flat sheets of glass to the softening temperature, press bending the heated sheets to a desired curvature between male and female mold members having complementary shaping surfaces and, finally, cooling the curved sheets in a controlled manner to either anneal or temper the glass sheets as dictated by their intended use. Such a bending technique is referred to as “press bending” and may suitably be carried out with the glass sheets oriented vertically, horizontally or obliquely.

In a mass production operation, the above operations are carried out successively while the sheets of glass are being advanced substantially continuously along a fixed path to a heating area, a bending area, and a cooling or tempering area. To achieve satisfactory temper in a glass sheet, the temperature of the glass must be above a predetermined minimum level so as to maintain the core or central portion above a deformation temperature upon being exposed to the tempering medium. The residual heat remaining in glass sheets of conventional thickness such as those having thicknesses ranging from 0.200 to 0.255 inch (5.08 to 6.48 mm), for example, is generally above such predetermined minimum level after bending for immediate advancement to the tempering area and exposure to the tempering medium. Thus, the heat initially imparted to the sheet to bring it to the proper bending temperature can also be utilized in the final heat treating tempering operation.

In past years, the majority of laminated windshields for the automotive industry were bent by the well known gravity, or sag bending technique, wherein a pair of superimposed sheets are simultaneously bent by the forces of gravity on a suitable skeletal-type mold. The technique, although highly successful, is considerably slower and more costly than the press bending process. Moreover, recent advancements in press bending technology have resulted in most instances, in a product that is of much higher quality than that produced by gravity bending. Thus, to provide an improved product and contain costs, there has been a growing trend to bending glass for windshields, when applicable, by the press bending process.

In the typical press bending operation after the sheet is formed between the opposed bending members, the bent sheet is immediately placed on either a roll conveyor or a carrier ring for transport out of the bending station into a cooling station. The lower press member is generally of ring-type construction and in the first method supports the sheet after bending and deposits it on the roll conveyor as the press member is lowered beneath the rolls. The sheet in the latter method is supported by an upper vacuum mold and deposited on the carrier ring immediately after bending. In either instance, during the initial cooling stage the perimeter of the hot glass sheet is in contact with a cooler, substantially continuous ring which accelerates cooling at the edges of the sheet relative to the central portion. This differential cooling has an effect on the ultimate stress pattern established in the sheet after it attains room temperature. When press bending thin glass sheets for windshields, this can result in permanent high stress areas inwardly of the peripheral edge of the sheet which increases the likelihood of breakage resulting from chipping, abrasions, stone hits and the like, during subsequent use in automobiles.

In order to obtain a uniform finish to the glass, it is preferable, in most instances, that the temperature of the mold be substantially uniform across the shaping surface thereof which contacts the glass. Conventional heating elements for male press molds of the solid or continuous type typically comprise spiral or coiled heating elements which project through the mold beneath the shaping surface.

U.S. Pat. No. 5,279,635 to Flaugher et al., illustrates a method an apparatus for a press bending process. This patent, which is hereby incorporated by reference in its entirety herein, illustrates a process and method for press bending glass articles. Flaugher et al. uses a heated male mold in the press bending of the glass.

U.S. Pat. No. 5,437,703 to Jacques et al., illustrates a molding method and apparatus for press bending glass. Jacques et al. utilizes a male mold with spiral wound heating elements running through channels cut through the mold body.

U.S. Pat. No. 3,753,673 to Pickard et al., illustrates another method for press bending glass sheets. Pickard et al. uses heating elements which are wound and embedded in the die. Refractory material is packed around the heating elements to give good thermal contact.

U.S. Pat. No. 3,854,920 to Kay et al., applies complementary bending surfaces at substantially the bending temperature of the glass and maintains those temperatures for a time sufficient to permit decay of thermal inhomogeneities and bending stresses.

The above described structures and methods are limited in the temperatures that can be generated by the male molds. It would be preferable to use a tool that can generate surfaces temperatures of at least 400° C. and preferably approaching 550° C. to 600° C. Additionally, the known methods are limited in that the surface temperatures across the press bending surfaces tend to be irregular. A more uniform temperature could improve the quality of the finished glass product. A further problem of the known male molds, is that when conventional heating elements fail, they tend to “explode”, essentially embedding themselves into the male mold, making it difficult or impossible to remove the failed heating element from the male mold.

### SUMMARY OF THE INVENTION

The present invention alleviates the above-noted shortcomings of the known devices by providing an improved male mold which utilizes heater elements which are disposed in the mold in a manner which substantially conforms to the outer surface contour of the male mold. The male mold is preferably a ceramic body with holes molded therein for flexible heater elements. The heater elements are preferably heating wires, for example nickel chromium (ni-chrome) wires which penetrate through the male mold at a substantially constant distance from the outer contoured surface of the male mold, thereby matching the contour of the male mold. The ni-chrome heating wires tend to fail in a manner that does not embed them into the male mold.

It is therefore an object of the present invention to provide an improved male mold for press bending sheets of glass, which maintains a more uniform surface temperature on the pressing surface, than those molds currently used in the field.

It is a further object of the present invention to provide an improved male mold for press bending sheets of glass, which can be heated to a higher temperature, preferably in excess of 400° C. and even more preferably to about 550-600° C. or greater on the pressing surface, than those molds currently used in the field. It is believed that the temperature can be increased up to the maximum temperature of the castable materials. A preferred castable material can be heated to about 1100° C.

It is also an object of the invention to provide an improved male mold for press bending sheets of glass, which utilizes less expensive heating elements than those molds currently used in the field.

An additional object of the invention is to provide an improved male mold for press bending sheets of glass, which utilizes heating elements which are simpler and more economical to replace than the heating elements typically used in the field.

Other objects and advantages will become more apparent during the course of the following description when taken in connection with the accompanying drawings.

### BRIEF DESCRIPTION OF THE DRAWINGS

In the drawings, wherein like numerals refer to like parts throughout:

FIG. 1 is a perspective view of male and female molds in accordance with the invention to be used for press bending glass;

FIG. 2 is an enlarged side elevational view of the male mold of the present invention, taken substantially along the line 2-2 of FIG. 1;

FIG. 3 is an enlarged sectional view taken along line 3-3 in FIG. 2;

FIG. 4 is an end view of an embodiment of the present invention; and

FIG. 5 shows an example of a known male mold.

### DETAILED DESCRIPTION OF THE PREFERRED EMBODIMENT

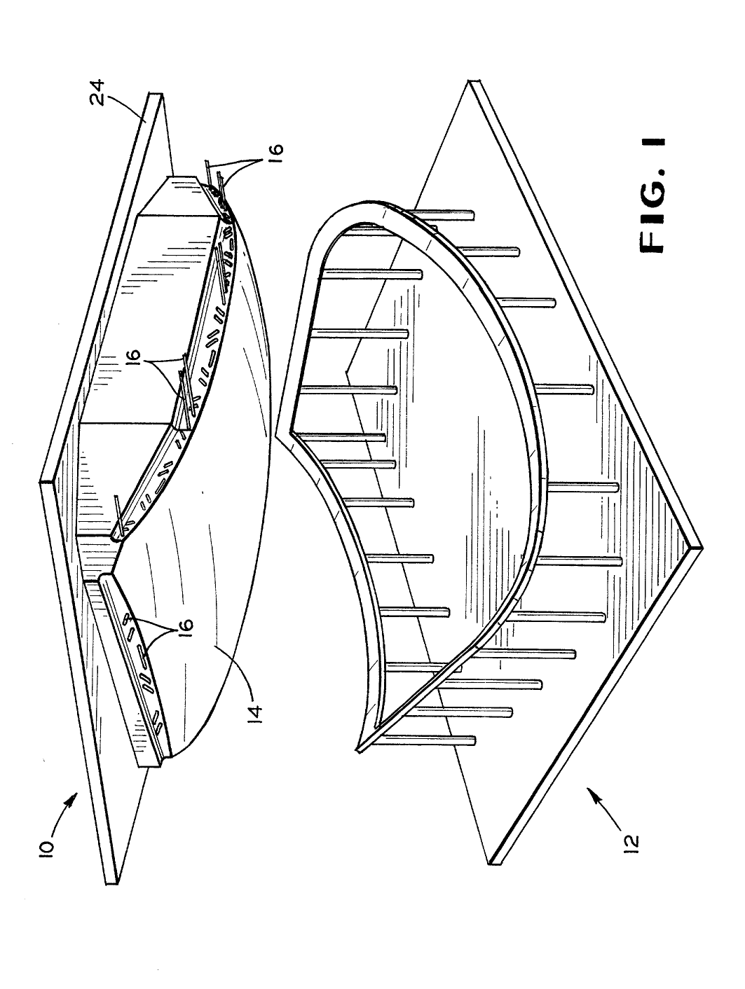

With reference now to the drawings, there is illustrated in FIG. 1, a male mold 10 and a female mold 12 as used for press bending glass. The molds are shown in a typical configuration for the press bending process, where the male mold 10 is positioned above the female mold 12 and presses down to form the sheet of glass between the molds. The male mold 10 has a pressing or shaping surface 14, which is designed to the contour desired for the finished sheet of glass. The male mold is also secured to a base plate 24. Additionally shown is at least one heating element 16, preferably a plurality of heating elements 16. The heating elements 16, as discussed hereinbelow, conform to the pressing surface 14 of the male mold in order to maintain the male mold at a substantially uniform temperature across its contour. While it is known to use metal male molds for the heating process, it is preferable to used a ceramic mold, such as, for example, a mold made from castable fused silica.

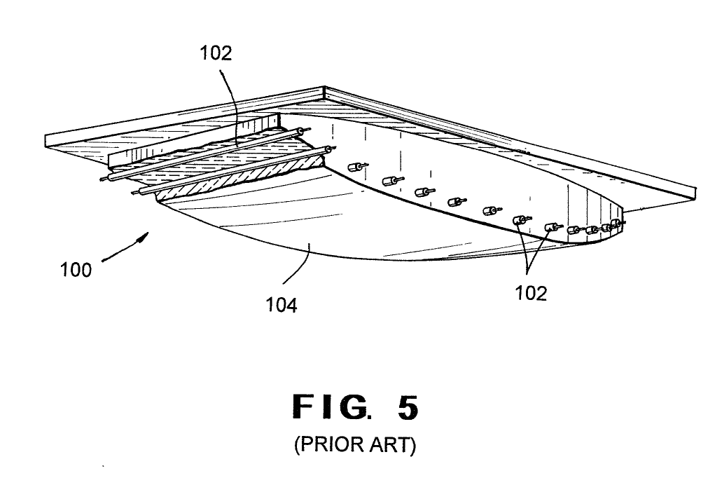

FIG. 5 illustrates a known male mold 100, including known heating elements 102. These heating elements 102 proceed linearly across the mold 100, and do not conform to the contour of the face 104 of the mold. An example of a known heating element would be the Watlow FIREROD® heating element cartridge. This cartridge includes a nickel-chromium resistance wire with magnesium oxide insulation inside an Incoloy® (registered trademark of the Inco family of companies) sheath. As discussed above, a common failing of these elements is that when the element fails, they tend to deform and expand, making it extremely difficult or impossible to remove from the mold.

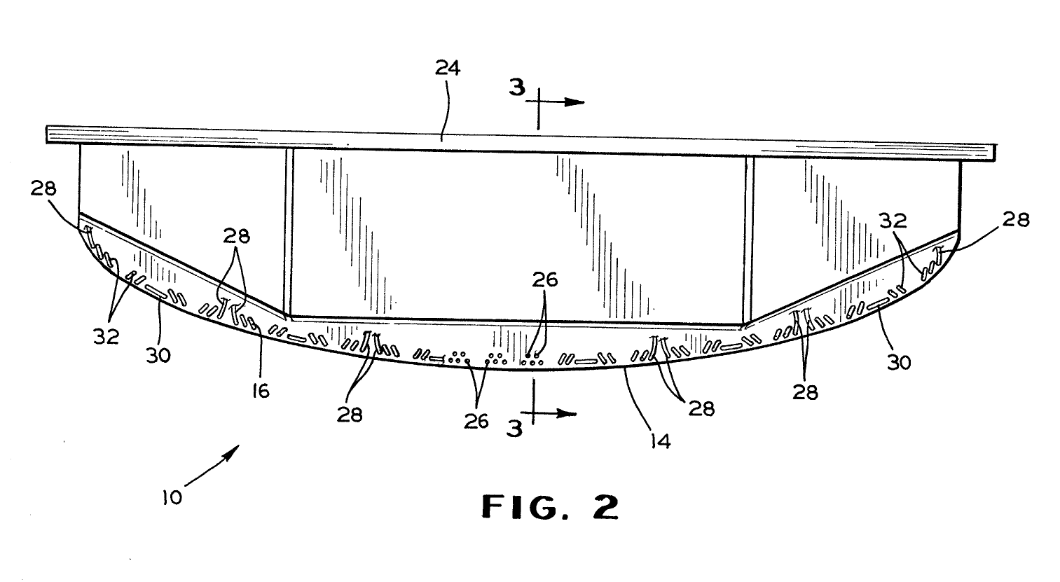

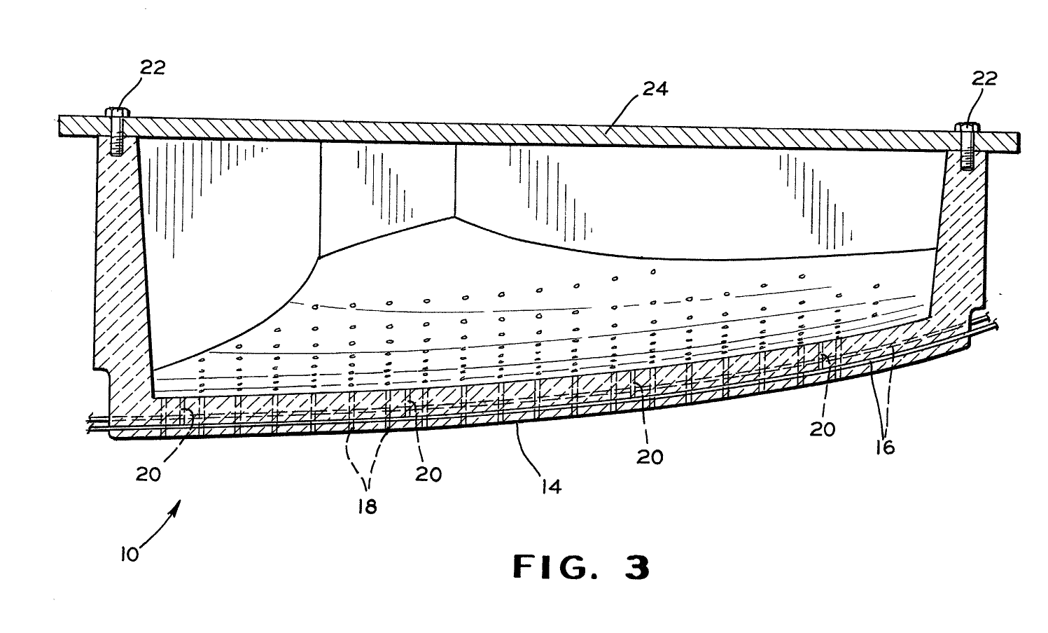

FIG. 2 is a side elevational view of the male mold 10 according to the present invention. The side view illustrates the curved or contoured pressing surface 14 of the male mold and the heating elements 16 running through the mold, conforming to the surface 14 of the mold (see FIG. 3). As used herein, conforming to the surface of the mold indicates that the path for the heating elements 16, through the male mold 10, maintain essentially a constant distance from the surface 14 of the male mold 10, whatever the contour of the surface 14 is. By maintaining the heating elements 16 at a constant distance from the surface 14, it becomes possible to achieve more uniformity of temperature at the surface 14 than has previously been attained.

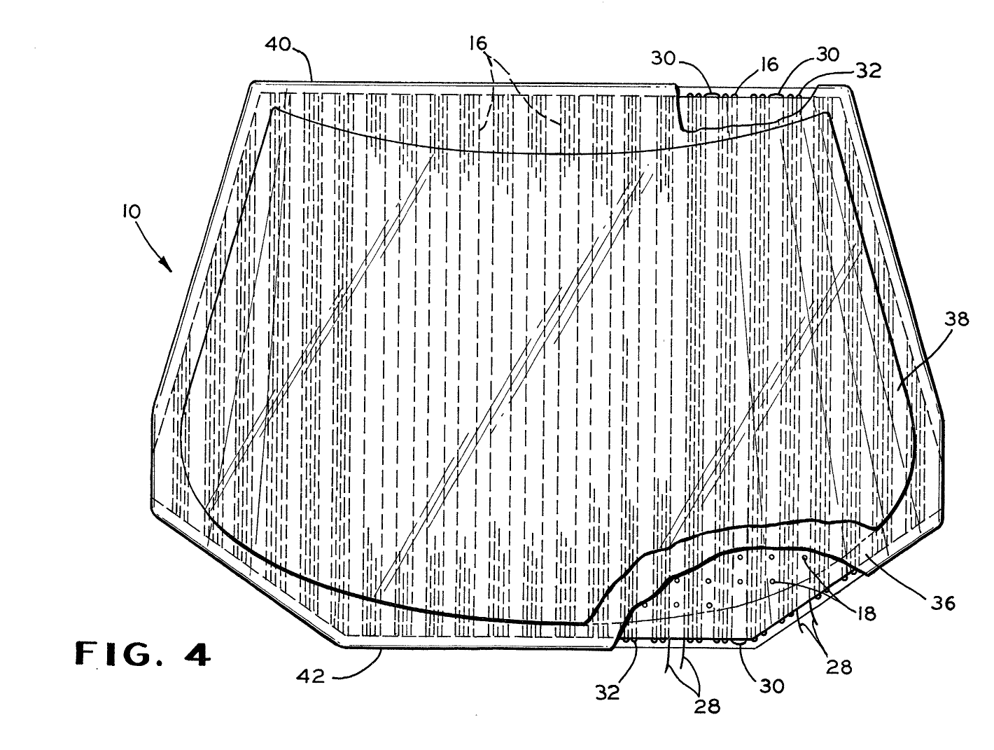

When used in a floatation system for the forming of the glass sheets, operation of the molds requires a vacuum to be maintained for positioning and control of the glass sheets. Therefore vacuum holes 18 (FIGS. 3 and 4) are disposed through the pressing surface 14 of the male mold. These vacuum holes allow for the negative pressure required to support the glass sheets during the pressing process. Additionally, thermocouples 20 are positioned in the male mold. The use of the thermocouples and vacuum holes is known in the flotation process for determining temperature at given points. Mounting bolts 22, among other methods, can be used to secure the male mold 10 to the base plate 24.

FIG. 3 illustrates a preferred embodiment of the heating elements 16. Typically, in conventional male molds for press bending operations, straight rod (rigid) heating elements are used, which project directly across the male mold. However, as shown in FIG. 3, ni-chrome heating wire, preferably about 12 gauge, is “threaded” through the male mold as the heating elements 16. As shown in this figure, it is preferable to run “clusters” of wire through the mold, preferably in a configuration of five wires, with three holes 26 closer to the surface 14 of the mold 10 and the two remaining holes 26 recessed from the surface 14. Many different configurations are possible for these heating wires. For example, it would be possible to run individual wires through each hole 26. While this configuration would be the simplest for replacing a defective wire, other configurations may be preferable.

If a separate wire is not used through each hole 26, a single wire is simply threaded through one of the holes 26 and at the other end of the mold 10, is threaded back through another hole 26, forming a loop 32 on the back face of the mold. Such a loop 32 is illustrated in this figure. It is also possible to use a separate wire to link between two heating wires through holes 30. As illustrated in this figure, ends 28 of the wires are all preferably located at the same end of the mold 10, while the other end of the mold has only loops 32. These ends 28 can be linked to one another, by any means customarily used for linking electrical wires, or can alternatively be independently linked to energy sources to provide heat to the male mold.

Additionally fasteners (not illustrated) can be used for attaching a cover (see FIG. 4) to the male mold. The fasteners are preferably simple snap type fasteners.

FIG. 4 illustrates a view of the shaping surface of the male mold, with a heat resistant cloth cover 36 and a glass sheet 38 positioned relative to the male mold. The cover 36 is preferably made from a heat resistant material, such as stainless steel woven, and is conventional in the press bending field. Typically in the press bending field, the male mold would be above the female mold with the glass sheet disposed between the molds. Therefore, this view is actually a “bottom” view of the male mold.

As each heating wire 16 is preferably threaded through the mold and back multiple times, this leaves disconnected ends that are to be connected to a power source for heating the wires. Cutaway sections of the cover 36 illustrate that all of these disconnected ends of the heating wires 16 are preferably located at the same end of the mold, leaving at the other end no discontinuities in the wires. This provides all the electrical connections to the heating wires at the same end of the mold.

It is significant to note that all of the heating wires 16 run essentially parallel to one another, as shown in this view. The vacuum holes 18 are also thus disposed in lines parallel to one another, between the clusters of wires. Heating elements in conventional molds tend to run in a “fan-shaped” pattern, projecting from a narrow end 40 of the mold 10 to a wide end 42 of the mold 10, thus avoiding the much shorter heating elements 16 disposed at the sides of the mold 10, as illustrated in this figure. Similarly the vacuum holes 18 were also conventionally arranged in this “fan-shaped” pattern. In conjunction with the present invention, it has been found that it is preferable to dispose the elements parallel to one another to help minimize temperature variation across the mold. The conventional disposition of the heating elements tends to create a higher temperature at the narrow end 40 than at the wide end 42, as the heating elements 16 are, of necessity, closer to one another at the narrow end 40 than the wide end 42.

The heating elements of the mold may be individually or zone regulated to assist in establishing an optimum temperature profile in the glass sheet conducive to proper bending. The temperature profile established in the heated sheet by the arrays of heating elements is coordinated with that established in the furnace and subsequently, modified by heat dissipation as the glass sheet advances to the bending station to achieve the proper bending temperature. The heating elements can also be utilized to create a temperature profile in the glass sheet generally higher than that originally established in the furnace.

It has been found that a preferred method for forming the holes for the heating elements in the male mold is to suspend a material through the mold during the forming of the mold. The material should preferably be able to hold its shape during the molding process and yet resilient enough to be easily removed from the male mold after the mold has been formed. Typically, the mold can be formed through a casting process, although other methods for forming the mold are possible within the scope of the present invention.

It has surprisingly been discovered that an O-ring stock material is especially suitable for the forming of the holes for the heating elements in the present invention. The material sufficiently holds its shape, during the formation of the mold, to form the passages that substantially maintain their distance from the surface of the mold, yet have been easily removed from the mold once the mold has been formed. Once the O-ring stock material has been removed from the male mold, the ni-chrome wire can be threaded through the passages, in the desired configuration. The O-ring stock material mentioned herein refers to commonly available cord designed for custom cutting into the desired sizes. A preferred example is Buna-N O-ring cord stock, McMaster Carr part No. 9679K22. This material is suitable for temperature ranges from −40 to 230° F., with a hardness of 70+/−5 Shore A durometer. While the above-listed material has a nominal diameter of 6.5 mm, the diameter chosen should be based upon the size of the heating wire used.

It is to be understood that the form of the invention herein shown and described is to be taken as a preferred embodiment only of the same, and that various changes in the size, shape and arrangement of parts, as well as various procedural changes may be made without departing from the spirit of the invention or the scope of the following claims.

What is claimed is:

1. An apparatus for press bending glass sheets comprising:
a male mold and a female mold positioned to press a glass sheet between them, said male mold having a pressing surface facing said female mold, said pressing surface having a contoured shape to press bend the glass sheet into a specific shape;
said male mold including a plurality of heating elements disposed through said male mold; and
each of said heating elements being disposed to substantially follow said contoured shape of said pressing surface to maintain a substantially constant distance from said pressing surface of said male mold.

2. The apparatus according to claim 1 wherein each of said heating elements is a conformal heating wire.

3. The apparatus according to claim 2 wherein said conformal heating wires are made of nichrome wire.

4. The apparatus according to claim 1 wherein said male mold is comprised of ceramic.

5. The apparatus according to claim 1 wherein said contoured shape of said male mold is designed to press the sheet of glass into the shape of one of a vehicle windshield or backlight or sidelight.

6. The apparatus according to claim 1 wherein each of said heating elements is substantially parallel to each other.

7. An apparatus for press bending glass sheets comprising:
a male mold having a pressing surface, said pressing surface having a contoured shape to press bend the glass sheet into a specific shape;
said male mold including a plurality of heating elements disposed through said male mold; and
each of said heating elements being disposed to substantially follow said contoured shape of said pressing surface to maintain a substantially constant distance from said pressing surface of said male mold.

8. The apparatus according to claim 7 wherein each of said heating elements is a conformal heating wire.

9. The apparatus according to claim 8 wherein said conformal heating wires are made of nichrome wire.

10. The apparatus according to claim 7 wherein said male mold is comprised of ceramic.

11. The apparatus according to claim 7 wherein said contoured shape of said male mold is designed to press the sheet of glass into the shape of one of a vehicle windshield or sidelight or backlight.

12. The apparatus according to claim 7 wherein each of said heating elements are substantially parallel to each other.

13. A method for making a male mold for press bending glass comprising the steps of:
providing a frame for casting the male mold;
suspending removable elastomeric tubes in the frame to form passages in the male mold;
positioning the removable elastomeric tubes in the frame to conform to the surface of the cast male mold;
casting the male mold;
removing the removable elastomeric tubes from the male mold after the male mold has substantially set to leave passages in the male mold; and
threading heating elements through the passages in the male mold.

14. The method of claim 13 wherein the removable elastomeric tubes are made of O-ring stock material.

15. The method of claim 13 wherein the male mold is cast from a ceramic material.

16. The method of claim 13 wherein the heating elements are made of nickel chromium wire.

17. A method for press bending glass sheets comprising the steps of:
positioning a male mold and a female mold to press a glass sheet between them, said male mold having a pressing surface facing said female mold, said pressing surface having a contoured shape to press bend the glass sheet into a specific shape, said male mold including a plurality of heating elements disposed through said male mold, and each of said heating elements being disposed to substantially follow said contoured shape of said pressing surface to maintain a substantially constant distance from said pressing surface of said male mold; and
pressing a glass sheet between the female mold and the male mold.

18. The method according to claim 17 wherein each of said heating elements is a conformal heating wire.

19. The method according to claim 18 wherein said conformal heating wires are made of nickel chromium wire.

20. The method according to claim 17 wherein said male mold is ceramic.

21. The method according to claim 17 wherein said contoured shape of said male mold is designed to press the sheet of glass into the shape of a vehicle windshield.

22. The method according to claim 17 wherein each of said heating elements are substantially parallel to each other.

23. A method of press blending glass sheets comprising the steps of:
providing a male mold having a pressing surface, said pressing surface having a contoured shape to press bend the glass sheet into a specific shape; said male mold including a plurality of heating elements disposed through said male mold, each of said heating elements being disposed to substantially follow said contoured shape of said pressing surface to maintain a substantially constant distance from said pressing surface of said male mold; and
pressing a glass sheet between said male mold and a female mold.
